(19) United States
(12) Patent Application Publication
(10) Pub. No.: US 2018/0122404 A1
(43) Pub. Date: May 3, 2018

(54) DETERMINING A BEHAVIOR OF A USER UTILIZING AUDIO DATA

(71) Applicant: International Business Machines Corporation, Armonk, NY (US)

(72) Inventors: Inseok Hwang, Austin, TX (US); Su Liu, Austin, TX (US); Eric J. Rozner, Austin, TX (US); Chin Ngai Sze, Austin, TX (US)

(21) Appl. No.: 15/336,614

(22) Filed: Oct. 27, 2016

(51) Int. Cl. G10L 25/63; G10L 15/30; G10L 15/18; G10L 17/06

(52) U.S. Cl. CPC G10L 25/63; G10L 15/30; G10L 2015/088; G10L 17/06; G10L 15/18

(57) ABSTRACT

A computer-implemented method according to one embodiment includes receiving audio data, processing the audio data to determine a plurality of words spoken by a user, and analyzing the plurality of words to determine a behavior of the user.

### BACKGROUND

The present invention relates to speech analysis, and more specifically, this invention relates to determining a behavior of a user by identifying and analyzing audio data created by the user.

The behavior of one individual may have a significant effect on the behavior of another individual. For example, the behavior of a first person in front of a second person (such as a peer of the first person, a colleague of the first person, an elder of the first person, a child of the first person, etc.) may have an influence on the behavior of the second person. However, it is difficult to monitor and analyze such behavior utilizing current techniques.

### SUMMARY

A computer-implemented method according to one embodiment includes receiving audio data, processing the audio data to determine a plurality of words spoken by a user, and analyzing the plurality of words to determine a behavior of the user.

According to another embodiment, a computer program product for determining a behavior of a user utilizing audio data comprises a computer readable storage medium having program instructions embodied therewith, where the computer readable storage medium is not a transitory signal per se, and where the program instructions are executable by a processor to cause the processor to perform a method comprising receiving the audio data, utilizing the processor, processing the audio data, utilizing the processor, to determine a plurality of words spoken by a user, and analyzing the plurality of words, utilizing the processor, to determine the behavior of the user.

A system according to another embodiment includes a processor and logic integrated with the processor, executable by the processor, or integrated with and executable by the processor, where the logic is configured to receive audio data, process the audio data to determine a plurality of words spoken by a user, and analyze the plurality of words to determine a behavior of the user.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 illustrates a method determining a behavior of a user utilizing audio data, in accordance with one embodiment.

FIG. 5 illustrates an exemplary behavior analysis environment, in accordance with one embodiment.

### DETAILED DESCRIPTION

The following description discloses several preferred embodiments of systems, methods and computer program products for determining a behavior of a user utilizing audio data. Various embodiments provide a method for identifying and analyzing audio data to determine spoken words, phrases, and non-word sounds within the audio data made by a user, and then analyzing the spoken words, phrases, and non-word sounds to determine a behavior of the user.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining a behavior of a user utilizing audio data.

In one general embodiment, a computer-implemented method includes receiving audio data, processing the audio data to determine a plurality of words spoken by a user, and analyzing the plurality of words to determine a behavior of the user.

In another general embodiment, a computer program product for determining a behavior of a user utilizing audio data comprises a computer readable storage medium having program instructions embodied therewith, where the computer readable storage medium is not a transitory signal per se, and where the program instructions are executable by a processor to cause the processor to perform a method comprising receiving the audio data, utilizing the processor, processing the audio data, utilizing the processor, to determine a plurality of words spoken by a user, and analyzing the plurality of words, utilizing the processor, to determine the behavior of the user.

In another general embodiment, a system includes a processor and logic integrated with the processor, executable by the processor, or integrated with and executable by the processor, where the logic is configured to receive audio data, process the audio data to determine a plurality of words spoken by a user, and analyze the plurality of words to determine a behavior of the user.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

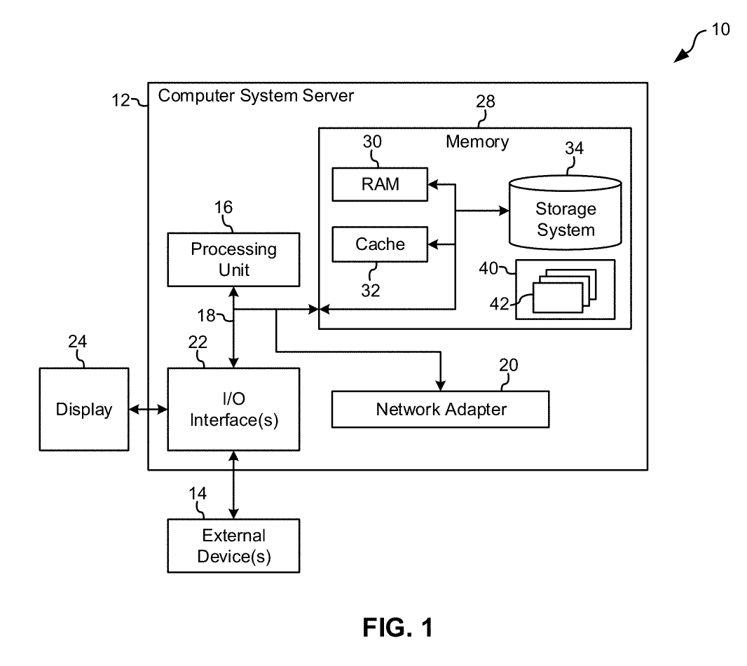

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

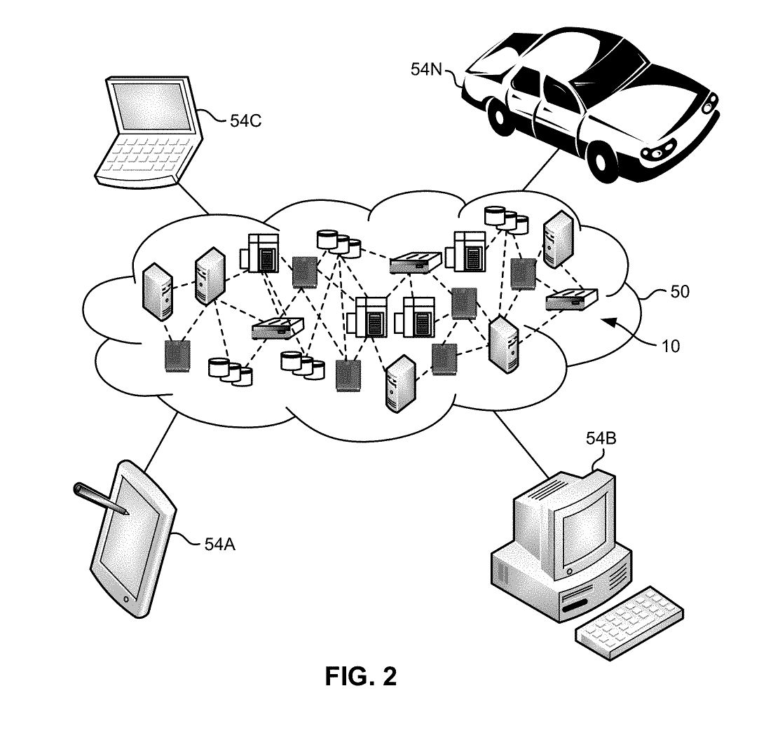

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

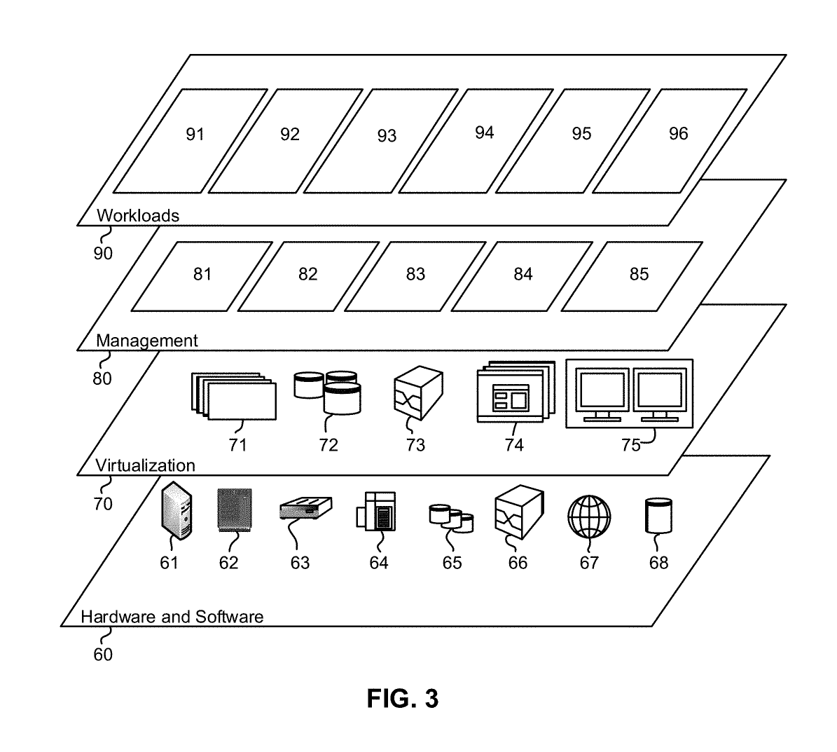

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and language and behavior determination 96.

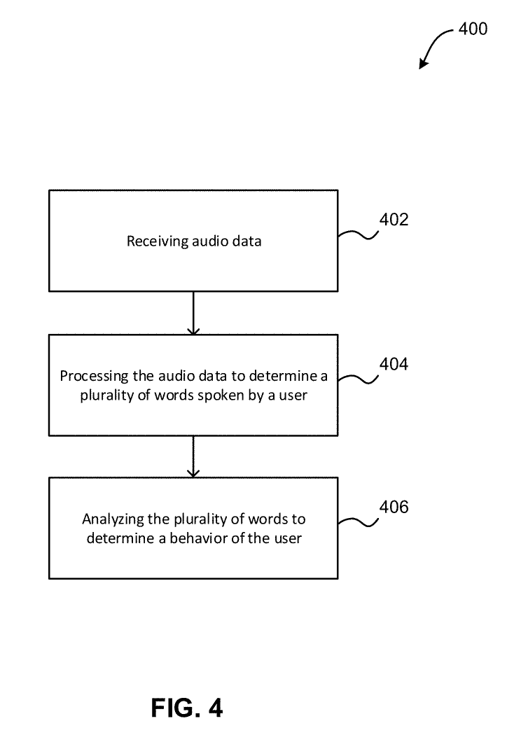

Now referring to FIG. 4, a flowchart of a method 400 is shown according to one embodiment. The method 400 may be performed in accordance with the present invention in any of the environments depicted in FIGS. 1-3 and 5, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where audio data is received. In one embodiment, the audio data may be received by one or more monitoring devices. For example, the audio data may be received by any device capable of receiving audio input (e.g., utilizing one or more microphones, etc.). In another example, the one or more monitoring devices may include one or more of a mobile computing device (e.g., a phone, a laptop computer, etc.), a game console, an interactive television, etc. In another embodiment, the one or more monitoring devices may receive the audio data by monitoring all sounds within a vicinity of the monitoring device.

Additionally, in one embodiment, the audio data may be received utilizing an application installed within a computing device. In another embodiment, the audio data may include spoken word data (e.g., one or more spoken words, etc.). For example, the audio data may include one or more verbal utterances made by one or more users. In another example, the audio data may include one or more verbal statements made by a user during a conversation, when a user is alone, etc.

Further, in one embodiment, the audio data may be associated with a single instance or multiple instances over a predetermined period of time. For example, the audio data may include a single instance of recorded audio that is associated with a predetermined time and/or location. In another example, the audio data may have one or more associated timestamps and/or geographical locations (e.g., locations obtained utilizing a global positioning system (GPS) module within the one or more monitoring devices, etc.).

Further still, as shown in FIG. 4, method 400 may proceed with operation 404, where the audio data is processed to determine a plurality of words spoken by a user. In one embodiment, processing the audio data may include performing one or more of sound and natural language processing on the audio data to determine textual data representing words and/or textual descriptions of sounds found within the audio data.

Also, in one embodiment, processing the audio data may include associating one or more users with one or more determined words and/or sounds. For example, processing the audio data may include identifying the user as a source of the plurality of words spoken by the user. In another example, processing the audio data may include identifying another user that is present when the plurality of words spoken by the user. In another embodiment, the user and other user may be associated with the plurality of words by comparing the audio data to one or more predetermined voiceprints for one or more users. For example, one exemplary technique to determine the source of the words and/or sounds is to use one or more voiceprint recognition systems.

In addition, in one embodiment, the processing of the audio data may be performed at the one or more devices that received the audio data. In another embodiment, the processing of the audio data may be performed may be performed by an external device such as a server computer or a cloud computing environment. For example, the audio data may be received at a mobile computing device and may be sent to a server computer and/or a cloud computing environment for processing.

Further still, as shown in FIG. 4, method 400 may proceed with operation 406, where the plurality of words are analyzed to determine a behavior of the user. In one embodiment, the analyzing may include identifying one or more patterns within the plurality of words spoken by the user. For example, the patterns may include one or more phrases, one or more sequences of predetermined words, etc. In another embodiment, analyzing the plurality of words may include comparing the one or more patterns to one or more predetermined patterns each associated with a behavior. For example, the predetermined patterns may be received via user input or may be extracted from one or more documents (e.g., one or more knowledge bases, one or more research papers, etc.).

Further still, in one embodiment, the analyzing may include identifying one or more predetermined keywords within the plurality of words. For example, this may be accomplished by comparing the plurality of words to a predetermined keyword database. In another embodiment, the predetermined keywords may be received via user input, may be extracted from one or more documents (e.g., knowledge bases, research papers, etc.), etc. In yet another embodiment, each of the predetermined keywords may be categorized within a database (e.g., as positive, negative, etc.).

Also, in one embodiment, analyzing the plurality of words may include determining a behavior associated with the one or more predetermined keywords identified within the plurality of words. For example, the behavior may be determined by performing a behavioral analysis on the one or more predetermined keywords and/or phrases that are identified within the plurality of words. In another example, the determined behavior may include a positive behavior, a negative behavior, a critical behavior, etc.

Additionally, in one embodiment, analyzing the plurality of words may include identifying a total number of instances of one or more predetermined keywords within the plurality of words. For example, a total number of keywords determined to be positive, negative, critical, vulgar, etc. may be calculated within the plurality of words.

Further, in one embodiment, the analyzing may be performed at the one or more devices that received the audio data. In another embodiment, the analyzing may be performed may be performed by an external device such as a server computer or a cloud computing environment. For example, the plurality of words may be determined at a mobile computing device and sent to a server computer and/or a cloud computing environment for processing. In another example, the plurality of words may be determined at the server computer and/or cloud computing environment and may also be processed at the server computer and/or cloud computing environment.

Further still, in one embodiment, the behavior of the user may be summarized in a report. For example, the report may be provided to the user and/or additional individuals. In another embodiment, the report may include one or more suggestions and/or recommendations for behavior improvement. In yet another embodiment, the report may be analyzed by another user (e.g., a spouse of the user, a peer of the user, a colleague of the user, an elder of the user, an administrator, etc.), and the additional user may provide additional comments that are added to the report. In this way, a report highlighting actual words spoken by a user may increase a persuasiveness of behavior-based suggestions made to the user.

Also, in one embodiment, an effect of the behavior of the user on a behavior of another user may be determined. For example, audio data may be received from a first user and a second user. Additionally, the audio data from both the first user and the second user may be processed to determine words spoken by the first user and the second user. Further, a behavior of the first user and the second user may be determined based on the spoken words.

In another embodiment, the behavior of the first user and the second user may be analyzed together to determine the effect the behavior of the first user has on the behavior of the second user. In yet another embodiment, the behavior of the second user may be tracked over time to determine any changes in behavior that are due to the behavior of the first user. For example, verbal interactions between a first person (e.g., an adult, etc.) and a second person (e.g., a child of the adult, a peer of the adult, an elder of the adult, a colleague of the adult, etc.) may be tracked in order to determine an effect the behavior of the first person has on a behavior of the second person over time.

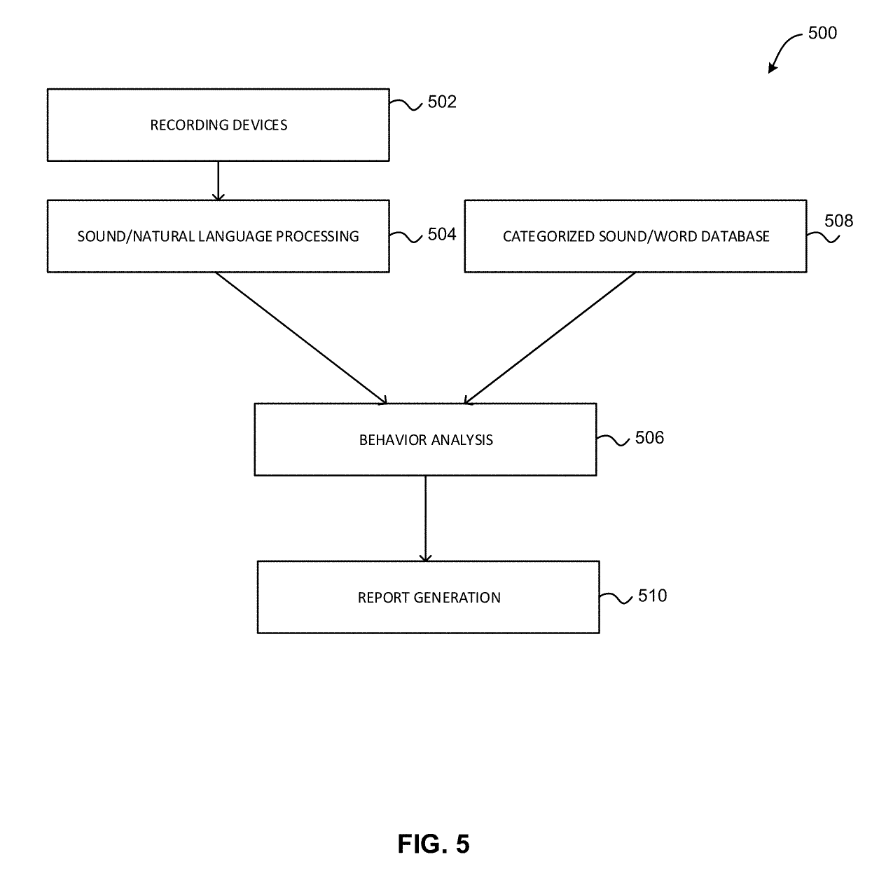

Now referring to FIG. 5, an exemplary behavior analysis environment 500 is shown according to one embodiment. As shown, the behavior analysis environment 500 includes a plurality of recording devices 502 in communication with a sound and natural language processing module 504. In one embodiment, the plurality of recording devices 502 may provide recorded audio data to the sound and natural language processing module 504. In one embodiment, the plurality of recording devices 502 may include one or more mobile computing devices such as mobile phones, etc. For example, one or more mobile devices may monitor and record all audio data within a range of a microphone of the device during one or more predetermined times, at one or more predetermined locations, etc. In another embodiment, the plurality of recording devices 502 may identify a speaker of the recorded audio data (e.g., by identifying a voiceprint of one or more users before or after recording the recorded audio data, etc.).

Additionally, the audio data may be sent from the plurality of recording devices 502 to the sound and natural language processing module 504, where the sound and natural language processing module 504 may process the audio data to determine one or more words, phrases, and non-word sounds present in the audio data. For example, the sound and natural language processing module 504 may use one or more audio processing techniques to identify words and phrases within the audio data. In another embodiment, the sound and natural language processing module 504 may also identify one or more non-word sounds (e.g., tongue clicking, whistling, etc.) within the audio data. In yet another embodiment, the sound and natural language processing module 504 may identify a speaker of the recorded audio data (e.g., by comparing the audio data to one or more predetermined sound signatures for various users, etc.).

Further, in one embodiment, the sound and natural language processing module 504 may be located within the one or more recording devices 502. In another embodiment, the sound and natural language processing module 504 may be located within a server device and/or a cloud computing environment. In still another embodiment, the sound and natural language processing module 504 may include software installed within one or more hardware devices.

Further still, the sound and natural language processing module 504 is in communication with a behavior analysis module 506. For example, the sound and natural language processing module 504 may return identified words, phrases, and sounds (as well as an identification of the speaker) to the behavior analysis module 506. The behavior analysis module 506 may then obtain categorized words, phrases, and sounds from a categorized sound and word database 508, where the categorized words, phrases, and sounds include words, phrases, and sounds that are identified as having one or more predetermined characteristics.

For example, the categorization of each word, phrase, and sound may include an indication that the word, phrase, or sound is positive, negative, critical, etc. In one embodiment, data within the categorized sound and word database 508 may be provided by one or more users. In another embodiment, the data may be extracted from one or more data sources (e.g., one or more research papers, Internet articles, etc.). In yet another embodiment, the sound/word database may contain data from different languages.

Also, the behavior analysis module 506 may analyze the words, phrases, and sounds identified within the audio data in association with the categorized words, phrases, and sounds in order to determine a behavior of an identified speaker of the words, phrases, and sounds identified within the audio data. The analysis may include a comparison of the audio data to the categorized data to identify one or more matches. The analysis may also include a determination of a number of predetermined types of words, phrases and sounds within the audio data (e.g., a number of negative words, critical words, etc.) or an identification of one or more predetermined patterns of interest (e.g. patterns that are associated with predetermined behavior, etc.).

In addition, the behavior analysis module 506 is in communication with a report generation module 510. For example, the results of the behavior analysis module 506 may be sent to a report generation module 510. In one embodiment, the report generation module 510 may include a summary of the analysis that may include a count of a number of predetermined words, phrases, and sounds made by a speaker, one or more predetermined patterns identified within the recorded audio data made by the speaker, etc. In another embodiment, the report generation module 510 may summarize a behavior of the speaker and may also provide one or more suggestions to improve the behavior of the speaker.

Furthermore, the report generation module 510 may provide the summary of the analysis to one or more additional users for their review and additional manual input (e.g., utilizing a graphical user interface (GUI), etc.). This additional input may be incorporated into the summary of the analysis to create a single report that is provided by the report generation module 510 to the speaker of the recorded audio data.

In one embodiment, one or more of the plurality of recording devices 502 may record a verbal interaction between two persons (e.g., where each person includes a parent, a child, an elder such as a grandparent, a daycare provider, a teacher, one or more peers, one or more colleagues, etc.) over one or more time periods. The sound and natural language processing module 504 may identify both the first and second persons, as well as the words, phrases, and non-word sounds spoken by the first and second persons. The identified words, phrases, and non-word sounds spoken by the first person may be sent to the behavior analysis module 506, which may compare the words, phrases, and non-word sounds to predetermined categorized/words, phrases, and non-word sounds from the categorized sound and word database 508 in order to categorize the content spoken by the first person and determine a behavior of the first person.

Additionally, the categorized content and identified behavior of the first person may be summarized and presented to the first person as a report, along with any behavioral suggestions, by the report generation module 510. In one embodiment, another individual (e.g., a spouse of the first person, a behavior specialist, a peer of the first person, a colleague of the first person, an elder of the first person, etc.) may review the summary of the first person's behavior and may add suggestions or further analysis to the report. In this way, the behavior of the first person may be effectively monitored and presented to the first person and other relevant parties.

Further, verbal utterances made by the second person before, during, and/or after the verbal interaction between the second person and the first person may be recorded and analyzed in a similar manner in order to determine a behavior of the second person at one or more periods in time. In this way, an impact of a behavior of the first person on the behavior of the second person may be determined and presented.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer-implemented method, comprising:
receiving, from a mobile device at a cloud computing environment, audio data including a first instance of recorded audio, where the first instance of recorded audio includes sounds made within a vicinity of the mobile device and is associated with a timestamp and a geographical location;
processing the audio data within the cloud computing environment utilizing natural language processing to determine textual data representing a plurality of words and non-word sounds spoken by a first user to a second user within the audio data, as well as an identification of the first user and the second user;
analyzing the plurality of words within the cloud computing environment to determine a behavior of the first user, including identifying one or more matches between the plurality of words and non-word sounds spoken by the first user to the second user and a plurality of categorized words and non-word sounds that are associated with predetermined behavior;
receiving, from the mobile device or another mobile device at the cloud computing environment, additional audio data occurring before and after the first instance of recorded audio, the additional audio data including additional instances of recorded audio that are each associated with an additional timestamp;
processing the additional audio data within the cloud computing environment utilizing the natural language processing to determine additional textual data representing an additional plurality of words and non-word sounds spoken by the second user within the additional audio data;
analyzing the additional plurality of words within the cloud computing environment to determine a behavior of the second user before the first instance of recorded audio and after the first instance of recorded audio, including identifying one or more additional matches between the additional plurality of words and non-word sounds spoken by the second user and the plurality of categorized words and non-word sounds that are associated with the predetermined behavior; and
determining within the cloud computing environment an effect the behavior of the first user determined during the first instance of recorded audio has on the behavior of the second user over time by analyzing the behavior of the first user determined during the first instance of recorded audio together with the behavior of the second user determined during the additional instances of recorded audio that occur before and after the first instance of recorded audio where the effect the behavior of the first user has on the behavior of the second user over time includes one or more changes in the behavior of the second user that are due to the behavior of the first user.

2. (canceled)

3. (canceled)

4. The computer-implemented method of claim 1, wherein processing the audio data includes identifying the first user as a source of the plurality of words spoken by the first user by comparing the audio data to one or more predetermined voiceprints.

5. The computer-implemented method of claim 1, wherein the cloud computing environment includes a plurality of remote processing devices that provides a set of functional abstraction layers and enables on-demand access to a shared pool of configurable computing resources.

6. The computer-implemented method of claim 1, wherein analyzing the plurality of words further includes:
identifying one or more patterns within the plurality of words spoken by the first user; and
comparing the one or more patterns to one or more predetermined patterns, where each of the one or more predetermined patterns is associated with the predetermined behavior, and where the one or more predetermined patterns were extracted from one or more knowledge bases and research papers.

7. The computer-implemented method of claim 1, wherein analyzing the plurality of words includes:
identifying one or more predetermined keywords within the plurality of words by comparing the plurality of words to a predetermined keyword database; and
determining a behavior associated with the one or more predetermined keywords identified within the plurality of words.

8. The computer-implemented method of claim 1, wherein:
the geographical location associated with the first instance of recorded audio includes a location of the mobile device obtained utilizing a global positioning system (GPS) module, and
the first instance of recorded audio includes results of monitoring all sounds within a vicinity of the mobile device, at a predetermined time associated with the timestamp, and at a predetermined location associated with the geographical location.

9. The computer-implemented method of claim 1, wherein the additional audio data includes sounds made within a vicinity of one or more monitoring devices other than the mobile device, and includes one or more verbal statements made by the second user when the second user is alone.

10. (canceled)

11. A computer program product for determining a behavior of a user utilizing audio data, the computer program product comprising a computer readable storage medium having program instructions embodied therewith, wherein the computer readable storage medium is not a transitory signal per se, the program instructions executable by a processor to cause the processor to perform a method comprising:
receiving from a mobile device, utilizing a processor at a cloud computing environment, audio data including a first instance of recorded audio, where the first instance of recorded audio includes sounds made within a vicinity of the mobile device and is associated with a timestamp and a geographical location;
processing, utilizing the processor, the audio data within the cloud computing environment utilizing natural language processing to determine textual data representing a plurality of words and non-word sounds spoken by a first user to a second user within the audio data, as well as an identification of the first user and the second user;
analyzing, utilizing the processor, the plurality of words within the cloud computing environment to determine a behavior of the first user, including identifying one or more matches between the plurality of words and non-word sounds spoken by the first user to the second user and a plurality of categorized words and non-word sounds that are associated with predetermined behavior;
receiving from the mobile device or another mobile device, utilizing the processor at the cloud computing environment, additional audio data occurring before and after the first instance of recorded audio, the additional audio data including additional instances of recorded audio that are each associated with an additional timestamp;
processing, utilizing the processor at the cloud computing environment, the additional audio data utilizing the natural language processing to determine additional textual data representing an additional plurality of words and non-word sounds spoken by the second user within the additional audio data;
analyzing, utilizing the processor at the cloud computing environment, the additional plurality of words to determine a behavior of the second user before the first instance of recorded audio and after the first instance of recorded audio, including identifying one or more additional matches between the additional plurality of words and non-word sounds spoken by the second user and the plurality of categorized words and non-word sounds that are associated with the predetermined behavior; and
determining, utilizing the processor at the cloud computing environment, an effect the behavior of the first user determined during the first instance of recorded audio has on the behavior of the second user over time by analyzing the behavior of the first user determined during the first instance of recorded audio together with the behavior of the second user determined during the additional instances of recorded audio that occur before and after the first instance of recorded audio, where the effect the behavior of the first user has on the behavior of the second user over time includes one or more changes in the behavior of the second user that are due to the behavior of the first user.

12. (canceled)

13. The computer program product of claim 11, wherein processing the audio data includes identifying, utilizing the processor, the first user as a source of the plurality of words spoken by the first user by comparing the audio data to one or more predetermined voiceprints.

14. The computer program product of claim 11, wherein the first instance of recorded audio includes all audio recorded at a predetermined location.

15. The computer program product of claim 11, wherein analyzing the plurality of words further includes:
identifying, utilizing the processor, one or more patterns within the plurality of words spoken by the user; and
comparing, utilizing the processor, the one or more patterns to one or more predetermined patterns, where each of the one or more predetermined patterns is associated with the predetermined behavior, and where the one or more predetermined patterns were extracted from one or more knowledge bases and research papers.

16. The computer program product of claim 11, wherein analyzing the plurality of words includes:
identifying, utilizing the processor, one or more predetermined keywords within the plurality of words by comparing the plurality of words to a predetermined keyword database; and
determining, utilizing the processor, a behavior associated with the one or more predetermined keywords identified within the plurality of words.

17. The computer program product of claim 11, wherein:
the geographical location associated with the first instance of recorded audio includes a location of the mobile device obtained utilizing a global positioning system (GPS) module, and
the first instance of recorded audio includes results of monitoring all sounds within a vicinity of the mobile device, at a predetermined time associated with the timestamp, and at a predetermined location associated with the geographical location.

18. The computer program product of claim 11, wherein the additional audio data includes sounds made within a vicinity of one or more monitoring devices other than the mobile device, and includes one or more verbal statements made by the second user when the second user is alone.

19. (canceled)

20. A computer-implemented method, comprising:
determining, at a mobile device, that a current time and a current location of the mobile device meet a predetermined time and predetermined location;
in response to determining that the current time and the current location of the mobile device meet a predetermined time and predetermined location, monitoring and recording as a first instance of recorded audio all audio data within a range of a microphone of the mobile device, where the first instance of recorded audio is associated with a timestamp and a geographical location;
processing, at the mobile device, the audio data utilizing natural language processing to determine textual data representing a plurality of words and non-word sounds spoken by a first user to a second user within the audio data, as well as an identification of the first user and the second user;
analyzing, at the mobile device, the plurality of words to determine a behavior of the first user, including identifying one or more matches between the plurality of words and non-word sounds spoken by the first user to the second user and a plurality of categorized words and non-word sounds that are associated with predetermined behavior;
recording, at the mobile device, additional audio data occurring before and after the first instance of recorded audio, the additional audio data including additional instances of recorded audio that are each associated with an additional timestamp;
processing, at the mobile device, the additional audio data utilizing the natural language processing to determine additional textual data representing an additional plurality of words and non-word sounds spoken by the second user within the additional audio data;
analyzing, at the mobile device, the additional plurality of words to determine a behavior of the second user before the first instance of recorded audio and after the first instance of recorded audio, including identifying one or more additional matches between the additional plurality of words and non-word sounds spoken by the second user and the plurality of categorized words and non-word sounds that are associated with the predetermined behavior; and
determining, at the mobile device, an effect the behavior of the first user determined during the first instance of recorded audio has on the behavior of the second user over time by analyzing the behavior of the first user determined during the first instance of recorded audio together with the behavior of the second user determined during the additional instances of recorded audio that occur before and after the first instance of recorded audio, where the effect the behavior of the first user has on the behavior of the second user over time includes one or more changes in the behavior of the second user that are due to the behavior of the first user.

21. The computer-implemented method of claim 1, wherein the additional instances of recorded audio that are each associated with the additional timestamp are also each associated with an additional geographical location.
